(19) United States
(12) Patent Application Publication
(10) Pub. No.: US 2009/0145742 A1
(43) Pub. Date: Jun. 11, 2009

(54) ENERGY TRANSFER THROUGH SURFACE PLASMON RESONANCE EXCITATION ON MULTISEGMENTED NANOWIRES

(75) Inventors: Chad A. Mirkin, Wilmette, IL (US); Wei Wei, Evanston, IL (US); Lidong Qin, Evanston, IL (US); Can Xue, Evanston, IL (US); Jill E. Millstone, Jacksonville, FL (US); Xiaoyang Xu, Evanston, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: NORTHWESTERN UNIVERSITY, Evanston, IL (US)

(21) Appl. No.: 12/331,928

(22) Filed: Dec. 10, 2008

Related U.S. Application Data
(60) Provisional application No. 61/012,826, filed on Dec. 11, 2007.
(60) Provisional application No. 61/051,729, filed on May 9, 2008.

(51) Int. Cl. B01J 19/12; G21G 5/00

(52) U.S. Cl. 204/157.15; 250/492.1

(57) ABSTRACT

Disclosed herein is energy transfer on multisegmented nanowires via surface plasmon resonance excitation of visible light, such as solar energy, absorbed by metals sensitive to visible light and transferred to metals insensitive to visible light. The nanowires are prepared with controllable gap sizes between different segments by on-wire lithography (OWL).

### CROSS REFERENCE TO RELATED APPLICATIONS

This application claims the benefit of U.S. Provisional Application No. 61/012,826, filed Dec. 11, 2007, and U.S. Provisional Application No. 61/051,729, filed May 9, 2008, each of which is incorporated herein by reference in its entirety.

### STATEMENT OF GOVERNMENTAL INTEREST

This invention was made with U.S. government support under the National Science Foundation (NSEC) Grant No. EEC-0647560 and Air Force Research Lab Grant No. FA8650-07-C-7729. The government has certain rights in this invention.

### BACKGROUND

Metallic nanomaterials have drawn attention for their unique surface plasmon resonance (SPR) properties and their wide range of potential applications in solar cells (Wen, et al., Sol. Energy Mater. Sol. Cells 61:97-105 (2000); Catchpole, et al. J. Lumin. 121:315-318 (2006); and Pillai, et al. J. Appl. Phys. 101:093105 (2007)), visible light-responsive photocatalysis (Li, et al. J. Am. Chem. Soc. 129(15):4538-4539 (2007); Watanabe, et al. Chem. Rev. 106(10):4301-4320 (2006); Burke, et al. Surf Sci. 585(1-2):123-133 (2005)) and light-emitting diodes (Catchpole, et al. J. Lumin. 121:315-318 (2006) and Okamoto, et al. Nature Mater. 3:601-605 (2004)). The signature optical property of certain metallic nanomaterials is the localized SPR, which is excited when a specific wavelength of light impinges on the material and causes a plasma of conduction electrons to oscillate collectively (Haynes, et al. J. Phys. Chem. B 105(24):5599-5611 (2001)). One consequence of exciting the localized SPR is the generation of locally enhanced electromagnetic (EM) fields at nanomaterial's surface. These enhanced fields are believed to dramatically enhance visible-light absorption and significantly improve the efficiency of photochemical reactions on the surfaces of these materials (Watanabe, et al. Chem. Rev. 106(10):4301-4320 (2006)).

A major obstacle in using SPR for the harvest and conversion of solar energy is that only three metals (gold (Au), silver (Ag), and copper (Cu)) provide very large field enhancement, because their SPRs can be efficiently excited by visible light, which accounts for 45% of energy from solar radiation (Anpo, Pure Appl. Chem. 72(9):1787-1792 (2000)). However, for applications such as photocatalysis, these metals are only marginally useful because they are generally chemically inert and only limited photochemical reactions occur on their surfaces under ambient conditions (Jin, et al. Science 294(5548):1901-1903 (2001) and Jin, et al. Nature 425:487-490 (2003)). On the other hand, for common photochemically active metallic materials, such as platinum (Pt), palladium (Pd), nickel (Ni), and ruthenium (Ru), their SPRs lie in the UV region of the spectrum, and therefore their direct excitation with sun light is not possible (Xiong, et al. J. Am. Chem. Soc. 127(48):17118-17127 (2005); Lin, et al. J. Raman Spectrosc. 36:606-612 (2005); and Lin, et al. Anal. Bioanal Chem 388:29-45 (2007)). Thus, a need exists for the development of new methods and materials that enable photochemically active metallic materials to employ visible light, e.g., by harvesting solar energy.

### SUMMARY

The present disclosure is directed to methods of activating a photochemically active metal using visible light. More specifically, disclosed herein are methods of activating a metal using visible light, wherein the metal is insensitive to activation by direct visible light.

The disclosed methods comprise exposing a nanowire to visible light, wherein the nanowire has at least two different metal segments, one of which comprises a first metal which is insensitive to SPR excitation by visible light and a second metal which is sensitive to SPR excitation by visible light. A nanowire segment comprising the second sensitive metal absorbs the visible light by excitation of a surface plasmon energy and transfers at least a portion of that energy to a nanowire segment comprising the first insensitive metal. The arrangement of the first and second metal segments along the nanowire allow for this energy transfer, wherein the first and second metal segments are separated by gaps, which allow the transfer of energy from the second sensitive metal to the first insensitive metal. The nanowire can comprise a plurality of segments and gaps, one or more first insensitive metals, and one or more second sensitive metals. These nanowires can be used as catalysts for a variety of chemical reactions, including CO oxidation, NO oxidation, epoxidation, methane oxidation, and water dissociation.

### BRIEF DESCRIPTION OF THE DRAWINGS

FIG. 1 contains scanning electron microscopy and confocal Raman microscopy images of multisegmented nanowires. FIG. 1(a) Left to right: a pair of 120±18 nm Au segments separated by a 30±8 nm gap and one Ag segment separated by a 120±15 nm gap from the Au disk pair, then a 1 μm gap, and one Au segment and one Ag segment with a 120 nm gap between the Au and Ag segments. FIG. 1(b) Left to right: individual Au disk pair; Au disk pair followed by a Ag segment separated by a 120 nm gap. FIGS. 1(c) and 1(d) are the corresponding confocal Raman microscopy images for nanowires (a) and (b) functionalized with pMA. The Raman signal intensities in (c) and (d) are not normalized and are not for direct comparison. FIGS. 1(e) and 1(f) show the line plot of the intensity of the Raman scattering along the long axis of the multisegmetned nanowires taken from images displayed in (c) and (d), respectively.

FIG. 2(a) Dark field extinction spectra of an individual Au disk pair, a Ag segment, and a multisegmented nanowire containing a Au disk pair and a Ag segment. The dotted line indicates the wavelength of the laser (632.8 nm) used in the Raman spectrum measurement. FIG. 2(b) Extinction coefficient for the three structures in (a) calculated by the discrete dipole approximation (DDA) method.

FIG. 3 shows the square-law dependence of the surface enhanced Raman scattering (SERS) signal from the junction of the Au nanodisk pair and the Ag segment with the power of the excitation laser, which indicates a non-linear (quadratic) relationship between the SERS and laser power.

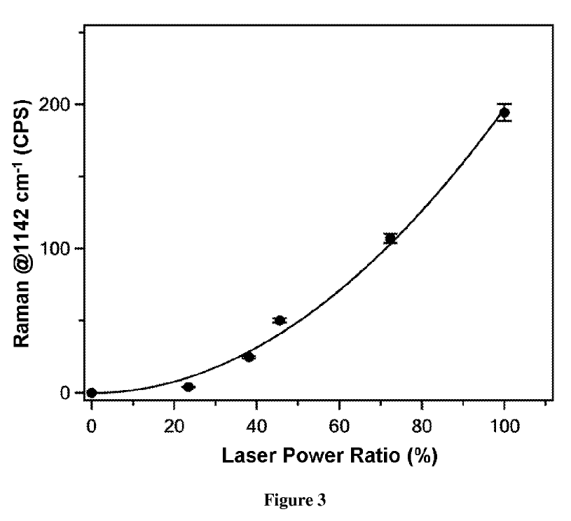

FIG. 4 (a) Optical microscopy and (b) confocal Raman microscopy images of a multisegmented nanowire that contains a Pt segment and a Ag segment separated by a 120 nm gap. The inset in (a) is a SEM image of the Pt segment and the Ag segment with the arrow indicating the 120 nm gap. The gap contains silica backing, as confirmed by the energy dispersive x-ray analysis (EDX).

FIG. 5 is a top view of the electric field enhancement of a disk pair (left) and a longer nanowire-like portion (right). The field enhancement is modeled at 632.8 nm radiation for a multisegmented nanowire that contains two 120 nm long Au segments separated by a 28 nm gap, and an Ag segment that is 120 nm away from the Au disk pair. The calculation was performed in vacuum by the discrete dipole approximation (DDA) method.

FIG. 6 is a scheme showing how visible light can be used to excite a surface plasmon resonance (SPR) of a metal having a SPR in resonance which can then transfer energy to a metal having an SPR out of resonance and, in turn, be excited indirectly by visible light.

FIG. 7 shows a schematic diagram for the energy levels of an Au disk pair and Ag segment.

### DETAILED DESCRIPTION

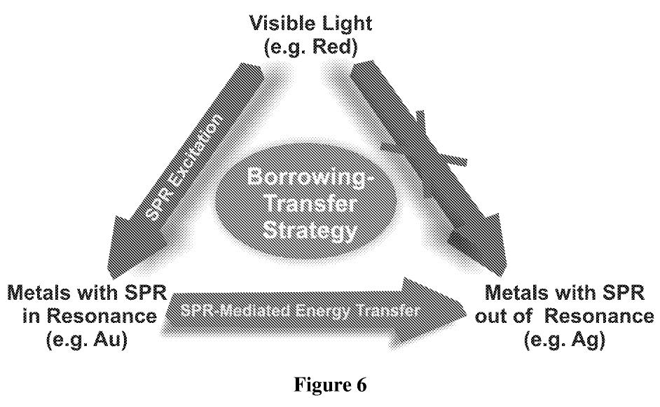

As disclosed herein, the scientific issues preventing direct solar energy excitation of photochemically active metals that are insensitive to visible light can be overcome by applying a “borrowing/transfer” strategy (FIG. 6). In this strategy, visible light (as solar energy) is absorbed by exciting the SPR from a metal sensitive to solar energy or light having a wavelength in the visible range (e.g., wavelengths of 400-750 nm). The energy can be transferred to the insensitive metal via SPR excitation if the two metals are positioned a suitable distance from one another, and their plasmon energy levels are well-matched, e.g., have a sufficient overlap to allow for SPR-mediated energy transfer. The transferred energy then can allow for activation of the insensitive metal by visible light in an indirect manner, i.e., through the activation of the sensitive metal and transfer of the energy to the insensitive metal. This activated insensitive metal can then, for example, be used as a catalyst for a reaction, such as a photochemical reaction on the surfaces of the now-activated insensitive metal.

As used herein, the term activating refers to altering a metal such that the metal has properties, physical, chemical, or the like, that it did not have prior to activation. For example, activating an insensitive metal using the disclosed methods can allow for the insensitive metal to be used as a catalyst.

Methods of fabricating the above-mentioned multisegmented nanowires having the desired dimensions, distances, and orientation of the nanowires are known. Lithography is one method. Among available lithographic approaches, on-wire lithography (OWL) is a particularly powerful nanofabrication method because of its reliability, resolution, flexibility, and throughput (see, e.g., U.S. Patent Publication No. 2007/0077429, incorporated herein by reference in its entirety). OWL is capable of making many types of metal nanostructures with dimensions that can be controlled from nanometers to micrometers. The OWL technique can be used to manufacture nanowires containing segments of different electrochemically-platable metals having plasmon modes that are suitable for energy transfer.

As used herein, a “nanowire” refers to a multisegmented nanorod having two or more metal segments separated by one or more gaps. As used herein, a metal also can refer to a metal alloy. The metal segments can be the same or different metals, but each nanowire contains at least one segment of a first insensitive metal and at least one segment of a second sensitive metal. At least one segment comprises a metal which is sensitive to visible light while at least one other segment comprises a metal which is insensitive to visible light. Nonlimiting examples of metals or alloys of the segments of the disclosed nanowires include gold, silver, nickel, copper, titanium, platinum, indium-tin-oxide, titanium tungstide, and mixtures thereof. Also contemplated as metals in the disclosed nanowires are cerium, zirconium, lithium, sodium, potassium, rubidium, cesium, magnesium, calcium, strontium, barium, aluminum, boron, gallium, indium, tin, lead, antimony, bismuth, scandium, yttrium, lanthanum, titanium, hafnium, vanadium, niobium, tantalum, chromium, molybdenum, tungsten, manganese, rhenium, iron, ruthenium, osmium, cobalt, rhodium, iridium, palladium, zinc, cadmium, thorium, uranium, silicon; zirconium with yttrium, scandium, aluminum or an alkali earth metal; titanium and an alkali or alkali earth metal, manganese, cobalt, nickel and iron in combination with lithium or another alkali metal, lithium and niobium, tungsten or molybdenum, barium with aluminium and platinum, aluminium with platinum or palladium, copper and aluminium or zirconium and zinc, lead and an alkali or earth alkali metal, tin and platinum, indium and tin or zinc, lanthanum and iron, manganese, cobalt or nickel, magnesium and/or aluminum.

As used herein, the term “sensitive to visible light” (alternatively referred to as “sensitive to solar energy”) refers to a property wherein when a metal is exposed to light having wavelengths typically within the visible region, e.g., about 400 nm to about 750 nm, a surface plasmon resonance is excited. Thus, a metal which is sensitive to visible light has a surface plasmon resonance which is capable of being excited by light having a wavelength of about 400 nm to about 750 nm. A metal which is insensitive to visible light (alternatively insensitive to solar energy), therefore, is a metal having a surface plasmon resonance which is excited by light having a wavelength outside of about 400 nm to about 750 nm. In some cases, a metal can be excited by certain wavelengths of light in the visible spectrum but not others. Thus, the sensitivity of the metal—i.e., whether it is sensitive or insensitive—will depend upon the wavelengths of light to which it is exposed.

Non-limiting examples of metals that are sensitive to solar energy (alternatively termed herein as a “sensitive metal”) and have surface plasmon resonances that can be excited by exposure to solar energy include gold, silver, and copper. In some cases, a metal is an insensitive metal when it is exposed to wavelengths of light in the visible range that do not excite a SPR, but is a sensitive metal when exposed to wavelengths of light in the visible range that do excite a SPR.

Non-limiting examples of metals that are insensitive to solar energy (alternatively termed herein as an “insensitive metal”) include, but are not limited to, platinum, palladium, ruthenium, rhodium, and aluminum.

The sensitive and insensitive metals in a nanowire typically also have plasmon energy levels that are compatible, meaning that the plasmon energy of the sensitive metal can transfer to the plasmon energy of the insensitive metal. By way of example, the plasmon energy of gold can transfer to silver or to platinum, as specifically shown below in the examples disclosed herein. Other combinations of metals (sensitive and insensitive) are contemplated, including any combination of sensitive metal listed above (e.g., gold, silver, and/or copper) and any insensitive metal listed above (e.g., platinum, palladium, ruthenium, rhodium, and/or aluminum). Also contemplated are nanowires having more than one sensitive metal and/or more than one insensitive metal. As a nonlimiting example, a nanowire having segments of gold, segments of silver, and segments of platinum is specifically contemplated.

The nanowires disclosed herein typically include segments of a sensitive metal of about 20 nm to about 5 μm. Segments of an insensitive metal can be about 20 nm to about 5 μm. The number of segments of each metal can be from 1 to 100. Typically, the sensitive metal comprises at least two segments of the nanowire, and they typically are adjacent to one another and separated by a gap. Also contemplated nanowires comprise 1, 2, 3, 4, 5, 6, 7, 8, 9, 10, 15, 20, 25, 30, 35, 40, 45, 50, 55, 60, 65, 70, 75, 80, 85, 90, 95, and 100 segments for each of the insensitive metal and the sensitive metal.

The nanowires disclosed herein have sensitive and insensitive metal segments separated by gaps of about 2.5 nm to about 300 nm. In some embodiments, gaps between segments of sensitive metals can be about 2.5 nm to about 50 nm. In various embodiments, gaps between an insensitive metal segment and a sensitive metal segment can be about 2.5 nm to about 300 nm. Additional gaps, the number and identities of segments of each metal, and the like can be judiciously selected, as necessary, to provide a disclosed nanowire capable of surface plasmon resonance excitation of the sensitive metal and a transfer of this energy to the insensitive metal. Specific gaps between two sensitive metal segments include 2.5, 5, 10, 15, 20, 25, 30, 25, 40, 45, and 50 nm. The gap distance between an insensitive metal segment and a sensitive metal segment is selected to allow for transfer of the energy from the sensitive metal to the insensitive metal. Specific gaps between insensitive metal segments and sensitive metal segments include 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200 nm.

Both gap sizes (i.e., the gap between the two or more sensitive metal segments and the gap between a sensitive metal segment and an insensitive metal segment) are important for the energy transfer. The gap size between two sensitive metal segments determines the efficiency of the light absorption of the sensitive metal. In some specific embodiments, the gap between two sensitive metal segments is about 30 nm gap when each sensitive metal segment is about 120 nm long (a ratio of 1:4 for gap to sensitive segment length). Other ratios of gap to sensitive segment length contemplated include 1:1, 1:1.5, 1:2, 1:2.5, 1:3, 1:3.5, 1:4.5, 1:5, 1:5.5, 1:6, 1:6.5, 1:7, 1:7.5, 1:8, 1:8.5, 1:9, 1:9.5, and 1:10.

The transfer of energy from the sensitive metal to the insensitive metal occurs when the plasmon resonance energy of the sensitive metal at least partially overlaps with the plasmon resonance energy of the insensitive metal, such that the energy can then transfer from the sensitive metal to the insensitive metal. If the plasmon energies of the sensitive and insensitive metals do not sufficiently overlap, the energy transfer cannot occur. It is not necessary for the surface plasmon energies of the sensitive and insensitive metals to completely overlap, but they should overlap sufficiently such that at least a portion of the energy absorbed by the sensitive metal can transfer to the insensitive metal. In some embodiments, the transfer of energy from the sensitive metal to the insensitive metal is at least about 20%, wherein the SPR of the insensitive metal is at least about 20%, at least 30%, at least 40%, at least 50%, at least 60%, at least 70%, at least 80%, at least 90%, or at least 95% the intensity of that of the SPR of the sensitive metal.

Gaps between the various segments can be optimized to allow for surface plasmon resonances and for surface enhanced Raman scattering (SERS), which can be used to detect energy transfer. The gap size between the sensitive metal segment and the insensitive metal segment determines the efficiency of SPR excitation and coupling, which are important for energy transfer. As the energy transfer is conducted through the field induction and coupling, the energy transfer efficiency will increase as the sensitive metal segment and the insensitive metal segment become closer. Techniques for measuring SPR excitation via SERS are disclosed in International Patent Publication WO 2007/064390, incorporated herein by reference in its entirety.

The disclosed nanowires and methods can be used in photocatalysis. The excitation wavelength for sensitive metal SPR is near or in the visible range, which accounts for 45% of energy from solar radiation. Because of their SPR excitation, the sensitive metal dramatically enhances visible light absorption. This energy can be transferred to the nearby insensitive metal, which can be photochemically active. This energy transfer, then, can enhance the photochemically active insensitive metal and its ability to act as a catalyst for a chemical reaction. Examples of possible chemical reactions that can benefit from such an energy transfer include CO oxidation, NO oxidation, methane oxidation, epoxidation reactions, and water dissociation.

### EXAMPLES

OWL was used to fabricate Au—Ag and Pt—Ag multisegmented nanowires having well-defined gaps between different metal segments. SERS, a spectroscopic phenomenon based on SPR (Qin, et al. Proc. Natl. Acad. Sci. USA 103(36):13300-13303 (2006); Xu, et al., Phys. Rev. Lett. 83:4357-4360 (1999); and Moskovits, Rev. Mod. Phys. 57:783-826 (1985)), was used to investigate the locally enhanced electromagnetic (EM) fields on these nanowires, and their ability to induce energy transfer across the multisegmented nanowires. The results disclosed herein demonstrate that energy can be efficiently transferred from a Au nanodisk pair to a Ag segment over a 120 nm distance through SPR excitation, indicating that the “borrowing/transferring” strategy can be used to harvest and convert visible light (solar energy).

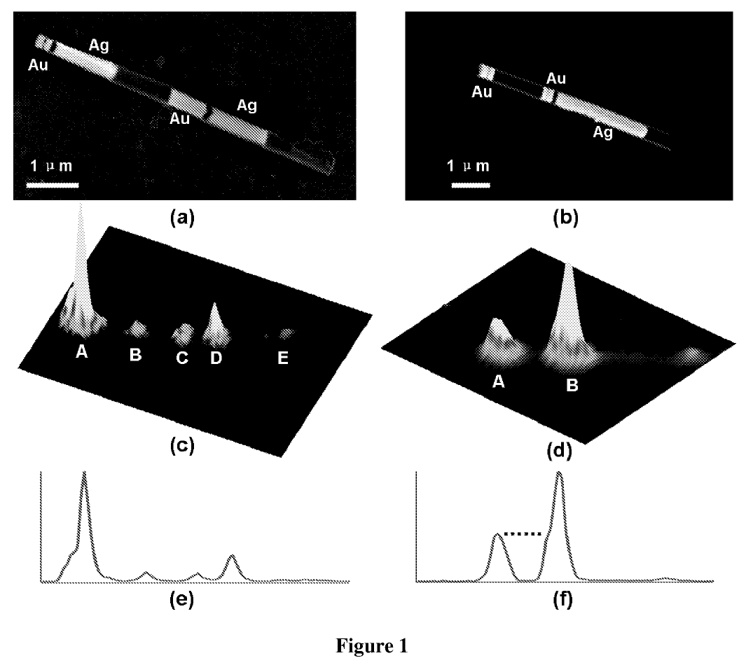

Scanning electron microscopy (SEM) images of the nanowires post-OWL show that the different segments on the wire are bridged with a hemi-cylindrical coating of SiO₂, which keeps the segments at a well-defined distance (FIG. 1). A typical nanowire structure containing two 120±18 nm Au disks separated by a 30±8 nm gap and one Ag segment isolated by a 120±15 nm gap from the Au disk pair was prepared using OWL procedures disclosed in U.S. Patent Publication No. 2007/077429 (FIG. 1a). These disk thicknesses and gap distances were chosen, because an OWL-generated structure with these dimensions exhibits the largest SERS enhancement (Qin, et al., Proc. Natl. Acad. Sci. USA 103(36):13300-13303 (2006)). To this basic structure, another 120 nm gap between a Au segment and a Ag segment was added.

Multisegmented nanostructures were prepared via the OWL method (US Patent Publication No. 2007/0077429). In a typical experiment, 360 nm-diameter Au—Ni—Au—Ni—Ag nanowires were synthesized by template directed electrochemical synthesis (Martin, Science 266:1961-1966 (1994); Possin, Rev. Sci. Instrum. 41:772-774 (1970); and Preston, et al., J. Phys. Chem. 97:8495 (1993)). The nanowires first were coated with a 50 nm layer of silica by plasma-enhanced chemical vapor deposition (PECVD), then the sacrificial Ni segments were dissolved, which created gaps between the Au—Au and Au—Ag segments along the long axis of the nanowires. By following the OWL process, the length of each segment is controlled with great precision, simply by controlling the number of Coulombs passed during electrochemical deposition. Segment number and composition also can be controlled such that it is easy to prepare wires with more than one gap and with gaps of different lengths (Martin, et al., Science 309(5731):67-68 (2005)).

Confocal Raman microscopy images taken of the post-OWL structures (FIG. 1c) illustrate the present methods. For Au and Ag segments, SERS signals were detected from the ends (point B, C and E, FIG. 1c), and there was no signal from the extended top surfaces. Interestingly, the most intense SERS signal was from the area that includes the Au disk pair and the junction between the Au disk pair and the Ag segment with a 120 nm gap (point A, FIG. 1c). A shoulder always was found on the left side of the most intense SERS signal, which is more clear in the plot of the cross section (FIG. 1e). To correctly assign this shoulder and the main peak, another multisegmented nanowire structure was prepared (FIG. 1b), in which two 120 nm Au disks separated by a 30 nm gap were added as a reference for the Au disk pair-Ag segment structure. In a Raman image (FIG. 1d), like the previous multisegmented nanowire, the most intense SERS signal was generated from the Au disk pair and the junction of the Au disk pair and the Ag segment with a 120 nm gap (point B, FIG. 1d). This SERS signal had a similar shoulder on the left side and more importantly, its intensity is the same as that from the individual Au disk pair (FIG. 1f). All of the above observations illustrate that the most intense SERS signal is from the junction of the Au disk pair and the Ag segment with a 120 nm gap. Additionally, the second most intense SERS signal was observed from the junction of the Au segment and the Ag segment with a 120 nm gap (point D, FIG. 1c). Though the surface area is larger for the junction in comparison to the single end of the Ag or Au nanowire segments (point B, C and E, FIG. 1c), the SERS intensities vary by more than a factor of 2.

p-Mercaptobenzoic acid (pMA) was selected as the Raman active molecule because it adsorbs onto Au and Ag surfaces through thiol-metal bonding and exhibits little fluorescence background (Wang, et al., J. Am. Chem. Soc. 127(43):14992-14993 (2005) and Jackson et al., Proc Natl Acad Sci USA. 101(52):17930-17935 (2004)). To effectively modify the surface with pMA, the nanowires first were isolated from an ethanol solution by centrifugation, and then resuspended in a 100 μL ethanol solution of pMA (10 mM) and shaken for 24 hours. The pMA-modified nanowires were subsequently isolated by centrifugation and repeatedly washed with ethanol to remove free and physisorbed pMA, and then cast onto piranha-pretreated glass substrates.

Raman spectra and images were recorded with a confocal Raman microscope (CRM200 WiTec) equipped with a piezo scanner and 100×microscope objective (NA=0.90, Nikon, Toyko, Japan). The spatial resolution was as high as 400 nm in this experiment. Samples were excited using a He—Ne laser (632.8 nm, Coherent Inc., Santa Clara, Calif.) with a spot size of about 1 μm and a power density of about 104 W/cm² on the samples. For a typical Raman image with a scan range of 15 μm×15 μm, complete Raman spectra were acquired on every pixel with an integration time of 0.3 seconds per spectrum and an image resolution of 100 pixels×100 lines. To provide a careful analysis of the enhanced Raman scattering signal of pMA on the sample features, all images presented were processed by integrating the intensity of the Raman spectra at 1142 cm⁻¹, which is attributed to the fundamental breathing mode of the aromatic ring (Osawa et al., J. Phys. Chem. 98:12702-12707 (1994)). The microscopic length of the wire allows one to spectroscopically address and distinguish each set of nanostructures decorating the silica layer backing along the long wire axis independently.

The SERS intensity is directly correlated with the strength of the locally enhanced EM fields that are generated by exciting the localized SPR on the surfaces (Qin et al., Proc. Natl. Acad. Sci. USA 103(36):13300-13303 (2006) and Moskovits, Rev. Mod. Phys. 57:783-826 (1985)). To have efficient excitation of localized SPR, the photon energy of incident radiation must be in resonance with the SPR mode that can be obtained from the extinction spectrum.

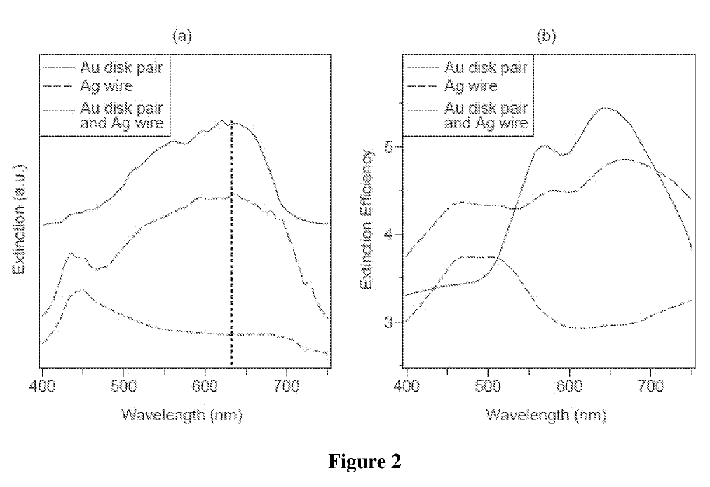

The dark field extinction spectrum of a single Ag nanodisk pair, single Ag nanowire, and Au—Ag multisegment nanowire were acquired using a Zeiss microscopy (Axiovert 100A) equipped with a CRAIC spectrometer (QDI301) and 100×microscope objective (NA=0.90, Nikon, Tokyo, Japan). A halogen lamp (HAL 100) was used as the light source. The Au disk pair showed SPR modes at λₘₐₓ of about 550 nm and 640 nm; for the Ag segment λₘₐₓ was about 450 nm (FIG. 2a). When the Au disk pair was brought into proximity with the Ag segment (separated by 120 nm), the extinction spectrum appeared to be a mixing of these two spectra, which agrees with theoretical calculations using the discrete dipole approximation (DDA) method (FIG. 2b). This observation indicated that the nearby Au disk pair did not change the absorption/scattering properties of the Ag segment and suggests that Ag segment itself could not have a strong SPR response to the 632.8 nm laser that was used for the SERS experiments. These results were consistent with the weak SERS signals observed from the ends of the Ag segments that are not gapped with an adjacent metal segment in the Raman images (point B, C and E, FIG. 1c).

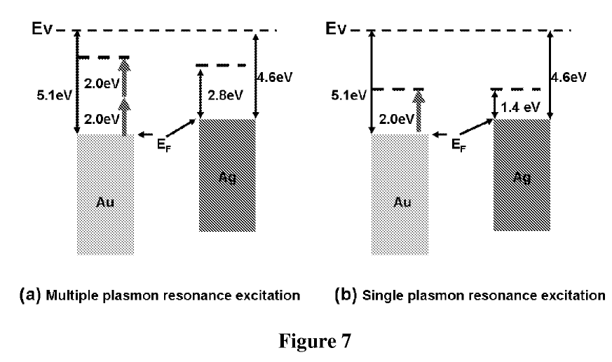

While a silver (Ag) segment has a weak surface plasmon resonance (SPR) response to a 632.8 nm laser, with this incident electromagnetic radiation, an intense surface enhanced Raman signal has been detected from the junction between a gold (Au) disk pair and a Ag segment that were separated by a 120 nm gap. Enhanced EM fields generated by Au SPR excitation with 632.8 nm laser induces the oscillation of conduction electrons (SPR) from the Ag segment and transfers energy to them. Then, the induced Ag SPR couples with the SPR from the Au disk pair to produce strong EM fields at their junction, and leads to a significant enhanced Raman signal. This energy transfer from the Au disk pair to the Ag segment can occur via multiple plasmon resonance excitations and/or a single plasmon resonance excitation (FIG. 7).

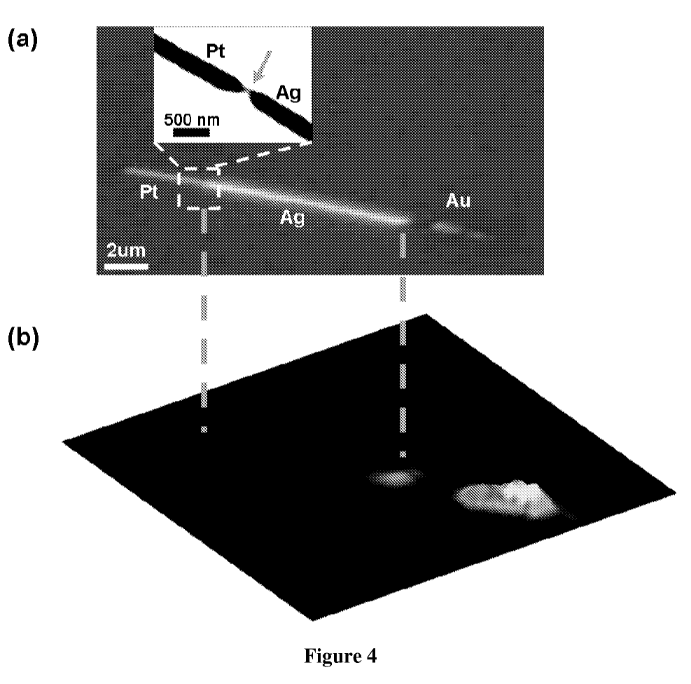

A nanowire structure was designed that contains a Pt segment and a Ag segment with a 120 nm gap (inset of FIG. 4a). It is known that the SPR modes of Pt are located in the UV region of the spectrum and are not in resonance with a 632.8 nm laser (Lin, et al., Anal. Bioanal Chem. 388, 29-45 (2007)). Assuming that the intense SERS signals is attributed to the Ag segment itself, the nearby segment can be Au or Pt, and the Pt—Ag junction should display a intense SERS signal similar to that observed for the Au—Ag junction. However, using this Pt—Ag nanostructure, a comparable SERS signal was not observed under identical experimental conditions as the Au—Ag nanostructure work (FIG. 4b). This indicates that the SERS signal observed in the first experiment was not a product of individual SPR from the Ag segment.

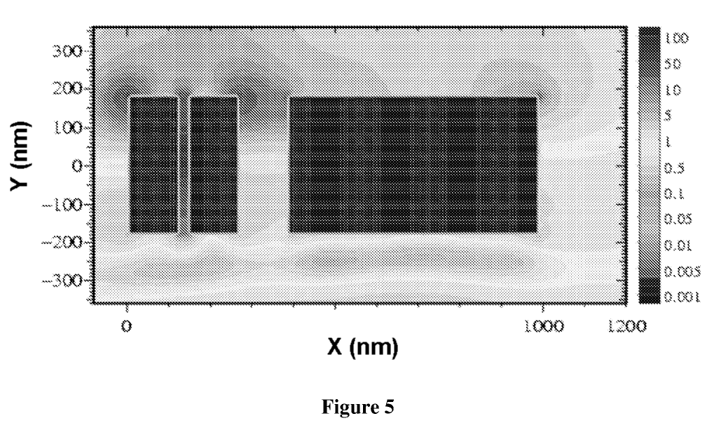

Theoretical modeling strengthens these conclusions. The extinction spectra (FIG. 2b) and the local electric field SERS enhancement factors (|E|²) of the cylindrical multisegmented nanowires (FIG. 5) were calculated in vacuum using the discrete dipole approximation (DDA) method. The structure used in the calculations consists of two gold nanodisks, each 120 nm in thickness and 360 nm in diameter, that are separated by a gap of 28 nm, plus a 600 nm silver nanowire with 360 nm diameter that is separated from the nearest gold disk by 120 nm. Other nanowire lengths were used in the calculations, and these led to similar results. The grid size used was 4 nm. The quantity plotted in FIG. 5 is |E|² with the initial polarization vector taken to be along the axis of the segments and initial wavevector pointing down (Other polarization directions produce smaller enhancements). The planes used for the SERS enhancement estimates are taken to be 4 nm from silver nanowire surface that is closest to the gold disk pair. The electromagnetic enhancement was calculated by averaging |E|² over this surface. Enhancements were also calculated for the other possible particle surfaces, but the only one which shows significant enhancement with the silver nanowire/gold nanodisk pair structure compared to the silver nanowire alone is the plane on the silver nanowire that is nearest the gold disk pair.

The SiO₂ film was not included in these calculations, which accounts for a small blue shift in plasmon resonance wavelengths from the model compared to the experiments. The working wavelength used in calculating the enhanced local electric fields between the Au disk pair was chosen to be the excitation wavelength of 633 nm. The mean of the incident and Stokes-shifted wavelengths of the experimental results at 669 nm were also examined, and the results were similar.

The local electric (E) fields of the multisegmented nanowires in vacuum were calculated using the DDA method (Qin et al., Proc. Natl. Acad. Sci. USA 103(36):13300-13303 (2006) and Kelly et al., J. Phys. Chem. B 107(3):668-677 (2003)) (FIG. 5). The |E|² SERS enhancement factor at 638.2 nm is shown in FIG. 5. The strongest E fields are located at the ends of the Au and Ag segments, rather than on their extended top surfaces. The strongest E fields are located in the 28 nm gap between the Au disks rather than at the end of the silver segment. This result is not directly related to the observed SERS signals, as the Raman intensity for molecules on these two metals is determined by additional factors beyond |E|⁴, such as surface coverage and roughness, which might be different from silver and gold. A more meaningful comparison is to determine the ratio of local field enhancements associated with the end of the silver nanowire in the presence and absence of the gold disk pair, as this should reveal the influence of plasmon excitation in the gold disk pair on the SERS signal associated with molecules at the tip of the silver nanowire. The DDA calculations show that the |E|⁴ enhancement factor increases from 13 for the silver nanowire in the absence of the gold disk pair, to 50 in the presence of the gold disk pair, indicating a factor of 4 enhancement effect associated with electromagnetic coupling over the 120 nm gap. This factor of 4 is independent of precise structural details such as the disk pair spacing, the grid spacing used in the DDA calculation, and roughness in the surfaces of the disk pair and silver particles. Explicitly including for the effect of the Stokes shift on the enhancement (i.e., calculating |E(ω)|²|E(6ω)|² rather than |E(ω)|⁴) increases the enhancement factor by a modest amount (from 4 to 6). The enhancement factor was calculated even more rigorously by determining the dipole emission intensity based on the formalism as described in Kerker et al., Appl. Opt., 19:3373, E4159 (1980). This led to a small decrease in the enhancement relative to those seen from |E|⁴.

In order to interpret the origin of the strongest SERS signal from the junction of the Au disk pair and the Ag segment, a hypothetical condition was created where a mixed beam of lasers with photon energies of 632.8 nm and 450 nm irradiates the junction of the Au disk pair and the Ag segment. The dark field extinction spectra show that the SPR modes are approximately 640 nm for the Au disk pair and 450 nm for the Ag segment. Therefore, the SPRs of both segments are excited using this mixed laser. The enhanced EM fields generated by the individual SPRs could have strong couplings and lead to the highest SERS signals. It is well known that generally the EM fields from Ag with SPR excitation are much stronger than that from Au, which shows that, in the disclosed experiments, the SERS intensity from the junction of the Au disk pair and the Ag segment was much higher than that from the Au disks.

In the experiments described herein, there is no light source other than the 632.8 nm laser. To excite the SPR from the Ag segment, there must be other external energy sources that function as a 450 nm laser. In these experiments, the strong SERS signal disappeared once the Au disk pair was replaced with a Pt segment at the junction. This phenomenon illustrates that the energy must be transferred from the Au disk pair to the Ag segment and excites the Ag segment's SPR. A plausible mechanism is theorized as follows: first, the 632.8 nm photon excites the SPR from the Au disk pair and generates the enhanced EM fields whose strength is a few orders of magnitude higher than the incident light field strength (Wanatabe et al., Chem. Rev. 106(10):4301-4320 (2006)). Next, the plasmon enhanced EM fields act as an incoming wave of high local intensity on the Ag segment, inducing the oscillation of conduction electrons (SPR) and transferring energy to them. These two processes lead to a coupling of the Ag SPR with the SPR from the Au disk pair, which results in the strong EM fields at the Au—Ag junction. The induced SPR from the Ag segment is exactly in phase with the SPR from the Au disk pair. This coherent coupling causes much stronger EM fields and efficiently assists the energy transfer, which is the key to the huge SERS signal observed from the Au—Ag junction.

Two possible channels could mediate the energy transfer from the Au disk pair to the Ag segment on the multisegmented nanowires: multiple plasmon resonance excitation and single plasmon resonance excitation. FIG. 7 shows a schematic diagram for the energy levels of the Au disk pair and Ag segment. The work function values were selected from Au(111) and Ag(111) (Skriver et al., Phys. Rev. B 46:7157-68 (1992)) as it has been suggested that the electrodeposited polycrystalline films have a predominate (111) texture. Simply comparing the energy, a single plasmon resonance excitation from the Au disk pair (632.8 nm, 2.0 eV) is not enough to induce the excitation of the SPR of the Ag segment at 450 nm (2.8 eV). However, if two surface plasmon resonances are excited simultaneously, the energy of doubly excited surface plasmons (4.0 eV) would be adequate for the induction of the excitation of the SPR from Ag (FIG. 7A). In fact, multiple plasmon excitations commonly happen on the surface of metallic nanostructures (Lin, et al., Appl. Phys. Lett. 88:101914 (2006); Lehmann, et al. Phys. Rev. Lett. 85:2921-24 (2000); and Kennerknecht, et al. Appl. Phys. B 73(4):425-9 (2001)). Lehmann, et al. (Phys. Rev. Lett. 85:2921-24 (2000)) reported that doubly excited surface plasmons on Ag nanoparticles could efficiently assist the excitation of conduction electrons and improve the photoemission yield up to 2 orders of magnitude. In addition, it is noted that the detection limit of the spectrometer used for the dark field extinction spectrum was from 400 to 750 nm. For a Ag segment with a cylindrical shape, there could be other available SPR modes above 750 nm, but these could not be detected. Zhao et al. (J. Appl. Phys. 100(6):063527 (2006)) have compiled DDA calculations for 80 nm Ag nanowire and shown a SPR mode at 850 nm in the extinction spectrum. The energy of a single surface plasmon resonance excitation (632.8 nm, 2.0 eV) from the Au disk pair is sufficient to excite this 850 nm (1.4 eV) SPR mode from the Ag segment (FIG. 7B). The good match of the energy levels in both mediation channels makes it possible for the efficient energy transfer through the surface plasmon resonance excitation on the multisegmented nanowires.

These results provide a promising avenue for using solar energy in photocatalysis and related areas. The excitation of SPR from the sensitive metals greatly improves the absorption of visible light (the major portion in the solar spectrum) and creates locally enhanced EM fields that can channel energy from absorbing species to reaction centers near photo-active metal surfaces. Once the photon energy matches the plasmon resonance, a very high excitation density can be easily achieved, which makes it possible to trigger multiple plasmon resonance excitations with weak radiation, such as sun light (solar energy).

With multiple surface plasmon resonance excitations, low energy photons can be used to initiate photochemical reactions that typically require high energy photons, such as the oxidation of CO on Pt (Tripa et al., Nature 398(6728):591-593 (1999)). Thus, in another embodiment, the methods disclosed further comprise using the excited metal (insensitive to solar energy) to catalyze a chemical reaction. In one specific embodiment, the chemical reaction is the oxidation of carbon monoxide (CO) to carbon dioxide (CO₂) and the excited metal is platinum. Other chemical reactions include those that comprise use of a platinum catalyst, e.g., other oxidation reactions, such as NO oxidation, methane oxidation, epoxidation, and water dissociation.

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those of ordinary skill in the art are deemed to be within the spirit, scope and concept of the invention as defined by the appended claims.

What is claimed:

1. A method of activating a first metal insensitive to visible light comprising
providing a nanowire comprising (i) at least one first segment comprising the first metal insensitive to visible light, (ii) at least one second segment comprising a second metal sensitive to visible light, and (iii) a gap between the first segment and the second segment;
exposing the nanowire to visible light such that the second sensitive metal absorbs sufficient energy to excite a surface plasmon resonance (SPR) of the second sensitive metal; and
transferring at least a portion of the energy absorbed by the second sensitive metal to the first insensitive metal to excite a SPR of the first insensitive metal.

2. The method of claim 1, wherein the at least one first segment has a thickness of about 20 nm to about 5 μm.

3. The method of claim 1, wherein the at least one second segment has a thickness of about 20 nm to about 5 μm.

4. The method of claim 1, wherein the first metal and the second metal are different and are each selected from the group consisting of gold, silver, nickel, copper, titanium, zinc, platinum, indium-tin-oxide, titanium tungstide, cerium, zirconium, lithium, sodium, potassium, rubidium, cesium, magnesium, calcium, strontium, barium, aluminum, boron, gallium, indium, tin, lead, antimony, bismuth, scandium, yttrium, lanthanum, titanium, hafnium, vanadium, niobium, tantalum, chromium, molybdenum, tungsten, manganese, rhenium, iron, ruthenium, osmium, cobalt, rhodium, iridium, palladium, zinc, cadmium, thorium, uranium, silicon, zirconium, yttrium, scandium, aluminum, titanium, manganese, cobalt, niobium, tungsten, molybdenum, barium, palladium, lead, tin, indium, lanthanum, manganese, magnesium and mixtures thereof.

5. The method of claim 1, wherein the first metal is selected from the group consisting of platinum, palladium, ruthenium, rhodium, and aluminum and the second metal is selected from the group consisting of gold, copper, and silver.

6. The method of claim 1, wherein the nanowire further comprises a third segment, wherein the second segment is positioned between the third segment and the first segment.

7. The method of claim 6, wherein the third segment and the second segment comprise the same metal and are separated by a gap of about 2.5 nm to about 50 nm.

8. The method of claim 6, wherein the first segment comprises platinum, and the second segment and the third segment each comprise gold.

9. The method of claim 6, wherein the third segment has a thickness of about 25 nm to about 100 nm.

10. The method of claim 1, wherein the first segment comprises platinum or silver and the second segment comprises gold.

11. A method of catalyzing a chemical reaction comprising,
providing one or more nanowires, each nanowire comprising at least one first segment and at least one second segment, said first segment comprising the first metal insensitive to visible light and said second segment comprising a second metal sensitive to visible light, and a gap between the first segment and the second segment;
exposing the one or more nanowires to visible light such that the second sensitive metal absorbs sufficient energy to excite a surface plasmon resonance (SPR) of the second sensitive metal;
transferring at least a portion of the energy absorbed by the second sensitive metal to the first insensitive metal to excite a SPR of the first insensitive metal thereby activating a catalytic property of the first insensitive metal segment; and
using the activated first insensitive metal to catalyze a chemical reaction.

12. The method of claim 11, wherein the first metal is platinum.

13. The method of claim 11, wherein the second metal is gold.

14. The method of claim 11, wherein the nanowire further comprises a third segment, wherein the second segment is positioned between the third segment and the first segment.

15. The method of claim 14, wherein the third segment and the second segment comprise the same metal and are separated by a gap of about 2.5 nm to about 50 nm.

16. The method of claim 14, wherein the first segment comprises platinum, and the second segment and the third segment each comprise gold.

17. The method of claim 11, wherein the reaction comprises oxidizing carbon monoxide to carbon dioxide.

18. The method of claim 11, wherein the reaction comprises epoxidizing a carbon-carbon double bond to an epoxide.

19. The method of claim 11, wherein the reaction comprises oxidizing methane to carbon monoxide or carbon dioxide.

20. The method of claim 11, wherein the reaction comprises dissociating water to hydrogen and oxygen.

21. The method of claim 11, wherein the reaction comprises oxidizing nitric oxide to nitrogen dioxide.
